(19) United States
(12) Patent Application Publication
(10) Pub. No.: US 2014/0378220 A1
(43) Pub. Date: Dec. 25, 2014

(54) Game Play Marketing

(71) Applicant: Heidi Smeder Fuller, Columbia, CA (US)

(72) Inventor: Heidi Smeder Fuller, Columbia, CA (US)

(21) Appl. No.: 14/226,456

(22) Filed: Mar. 26, 2014

Related U.S. Application Data
(60) Provisional application No. 61/805,739, filed on Mar. 27, 2013.

(51) Int. Cl. A63F 13/61; A63F 13/33

(52) U.S. Cl. CPC A63F 13/61; A63F 13/33
USPC 463/31

(57) ABSTRACT

A system and method for business establishments to market, advertise and incentivize consumers to frequent their businesses thorough the medium of the virtual world of a role playing game. A virtual world is populated with virtual, graphic representations of real business locations. One area of the virtual world is populated with virtual, graphic representations of real business locations downloaded from a data base selected for the subscribing businesses' proximity to a postal code entered by the player. The interiors of the business location are represented as game play areas within the virtual world. Characters in the game present advertising and marketing information, and present challenges to the player some of which require visits to the actual business location. The player is rewarded with coupon points for the interactions that can be redeemed at the subscribing businesses' physical locations and game advancement.

### CROSS-REFERENCE TO RELATED APPLICATIONS

This application claims priority from provisional patent application Ser. No. 61/805,739, filed on Mar. 27, 2013.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

a. Field of the Invention

This invention generally relates to advertising, marketing and incentivizing patronage of business establishments through the use of role-play gaming.

b. Description of Related Art

The goal of any business owner is getting new faces through the doors while retaining the patronage of established customers. Business owners commit a great deal of time, effort, and resources developing a customer base and promoting customer loyalty. Traditionally, this has been done through advertising, incentives such as sales, and special offers to frequent and returning customers. Traditional advertising in newspapers, magazines, television and radio consists of many businesses purchasing advertising spots which are then dependent on the popularity of the content to ensure viewers for the advertisements. Gaming and online advertisement has followed this traditional passive model: advertisements pop up at various points in games or websites selected by the advertising business owner for the content and popularity of the game or website. The advertisement is effective only if the potential consumer a) actually looks at the ad, and b) finds the product advertised of enough interest to him to click on the ad; otherwise, the user simply ignores the advertising. As advertising on the internet has become ubiquitous, internet users have become more adept at avoiding it by turning them off, blocking it entirely with available programs or paying extra for advertisement free content.

Gaming has increasingly been used as an advertising vehicle. Ads regularly pop up on games offered for free over the internet. Additionally, games have been developed based on particular individual franchises; these individual games are not an effective or efficient model since, for 100 businesses, a consumer would have to play 100 individual games. This is akin to each company developing its own newspaper with original content in which to advertise its own products.

Thus, there are three problems for which solutions are needed: first, an entertaining vehicle attractive to consumers through which multiple businesses establishments may actively engage consumers, build a continuing relationship, and incentivize both views of their advertisements and real world interactions on a continuing basis; second, an incentive for consumers to view business advertisements and visit business locations other than purely personal interest in the particular business or products; and third, enable consumers to receive and accumulate incentives from multiple businesses at one online location.

This business method invention solves all three problems. This invention provides a larger fantasy adventure gaming world within which virtual representations of real businesses are an integral part of the game play. Player must visit the businesses to solve mysteries and carry out tasks that advance the storyline and game play. The player is rewarded within the game play for visiting both the real and virtual business locations with points, virtual gold coins and other items and information that advance game play and the player's achievement levels. Additionally, the player is rewarded with “real-world” incentives for advancing in the game and viewing advertisements and content provided by the individual participating businesses in the form of coupon points and other prizes that can be redeemed at the actual business locations.

### SUMMARY OF THE INVENTION

A game is provided for simultaneous play by an unlimited number of users through a real time interactive network. The game is played in the third person so that the player controls an avatar that represents his presence in the game. The player logs in providing, at least, an email address, password, username, country and a preferred postal code. The game starts at a “home base” from which each player begins his adventure. It is an area that can be customized and that the player may decorate with items signifying game achievements which are collected as he advances through the game. The player's avatar meets a character who gives a short explanation of the game to the player and begins the game by sending the player on his first adventure. The first part of this first adventure includes travel through a village that is populated with virtual representations of actual businesses that have subscribed to participate and advertise in the game along with fictional locations to advance the game play. The village is populated with the virtual business representations chosen from a database of subscribing businesses based on the relative proximity of the location of the business' postal code to the postal code of the player. The player's avatar may “enter” each of these virtual business locations as well as locations that are purely part of the storyline. Inside these locations, the player will encounter characters that will a) give information about the business and game, b) show advertisements, c) require some sort of interaction with the “real-world” business to complete mini-quests, or d) advance the main story line. The player may obtain various items to advance the main story line at subscribing business locations which are appropriate to that part of the story line; for example, if the player is searching for a rope, it might be found at a market that represents an actual business that sells such items. The story line will change and advance over time and new adventures will be added for players that have completed all of the available adventures so that once one adventure is complete another will begin. The storyline will take the player through fantasy locations such as troll caves and fairy villages as well as virtual representations of real locations such as a historical state park or a town that is a tourist destination in Costa Rica, or a specific resort in Mexico. The virtual representations of real world locations will include virtual representations of the real world businesses that exist in those locations and subscribing businesses will be part of the storyline adventures.

The player has an inventory chest to keep track of items he has collected throughout the game and may need to complete particular quests within the larger adventure storyline on which he is working. There also is a traditional “heads up display” to keep track of level points and energy points, and gold and jewels he has collected and at his disposal. Additionally, there is a coupon inventory with which the player keeps track of the number of coupon points he has collected from the real-world businesses represented in the game. The player may return to the virtual businesses that he regularly frequents or plans to frequent in the real world to click on new ads to collect more coupon points and work toward rewards offered by those businesses.

The player can print out coupons once he has achieved the appropriate number of coupon points set by the individual business for a reward.

A business owner pays a subscription fee to have a virtual representation of a business included in the game. The fee reflects the number of characters that will be included at the virtual business location, the type of the interaction possible (i.e., informational conversation only, pop up advertising, mini quest or question challenges), how often the content may change (i.e., unchanging, monthly, weekly, daily), and how much virtual “real estate” is dedicated to the subscribers business.

The business owner accesses the game account through an internet based web portal. Through this web portal, the business owner views game statistics on number and rate of player visits, and coupon points earned, updates its advertisements, updates character dialog, and updates mini quests. Additionally, the business owner may record any coupon redemptions at its actual business location for those customers who neglected to bring a coupon or other evidence of point accumulation.

### DESCRIPTION OF THE DRAWINGS

FIG. 1 is a block diagram of the system of this invention;

FIG. 2 is a block diagram of the experience of the game player;

FIG. 3 is a flow diagram of the process of this invention;

FIG. 4 is an illustration of a possible main game screen seen by the player.

FIG. 5 is an illustration of a possible “Coupon Inventory” screen seen by the player.

FIG. 6 is an illustration of a possible individual business screen seen by the player when he clicks on a coupon icon in the coupon inventory.

FIG. 7 is an illustration of a possible interior scene seen by the player when his avatar enters a virtual representation of a subscribing business.

FIG. 8 is an illustration of a possible game screen seen by the player showing a challenge question.

FIG. 9 is an illustration of a possible game screen seen by the player that shows after the player has correctly answered the challenge question that earns coupon points.

FIG. 10 is an illustration of a possible “Game Overview” menu screen seen by a subscribing business owner to view game statistics.

FIG. 11 is an illustration of a possible “Character Interface” menu screen seen by a subscribing business owner to update character interactions, advertising, and mini quests seen by the players.

FIG. 12 is an illustration of a possible “Customer” menu screen seen by a subscribing business owner to view coupons accumulation and redemptions by a player and do onsite redemptions.

FIG. 13 is an illustration of a possible “Incentives” menu screen seen by a subscribing business owner to update incentive offers, update the business icon displayed in the game, update the description displayed in the game, and any website.

FIG. 14 is an flow diagram of the cycle created by the invention.

### DETAILED DESCRIPTION OF THE INVENTION

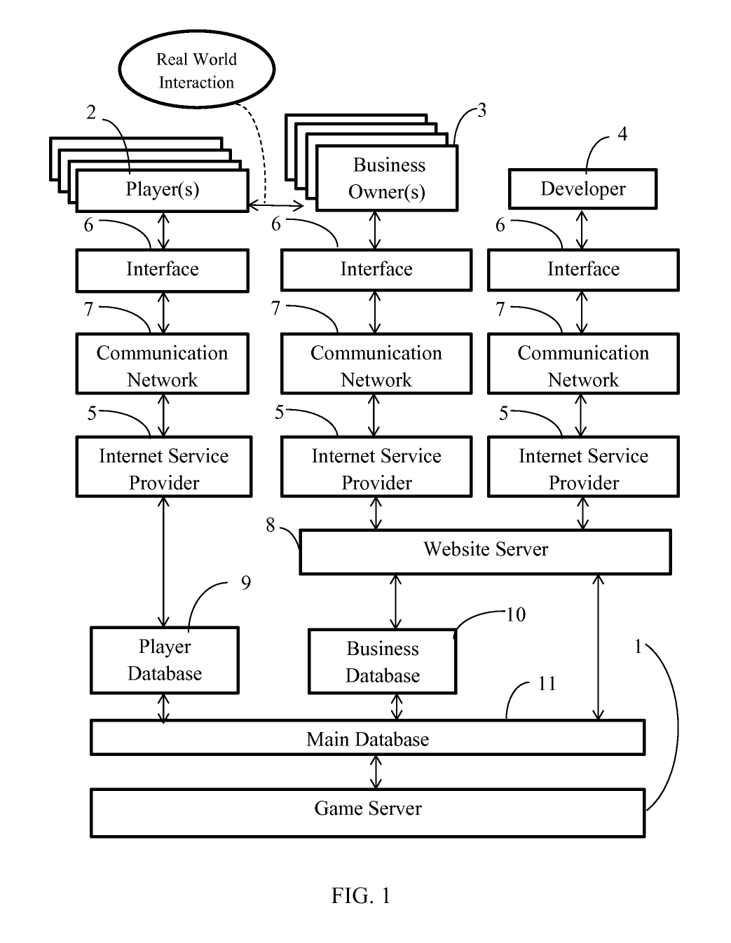

The system of this invention is shown in FIG. 1 and consists of a game server 1, which is accessible by a player 2, a business owner 3 and the developer 4 through an internet service provider 5. The internet service provider 5 is accessible in a known manner through an interface 6 (i.e., smart phone, tablet, etc.) connected through a communications network 7. The game server 1 is constructed to be compatible with a wide variety of internet and extranet servers or directly by the player or participating business owner depending on the available communication networks and protocols. The subscribing business owner 3 enters and updates his information through a website on a web server 8. The business owner's information is stored in the business database 10. Information from the business database 10 is loaded into the main database 11 from which the game server 1 draws game information. The player 2 enters and updates his information through the game software resident on the game server 1 and on his interface 6 device. The player's information is stored in the player database 9 which will then be loaded into the main database 11 from which the game server 1 will draw the information.

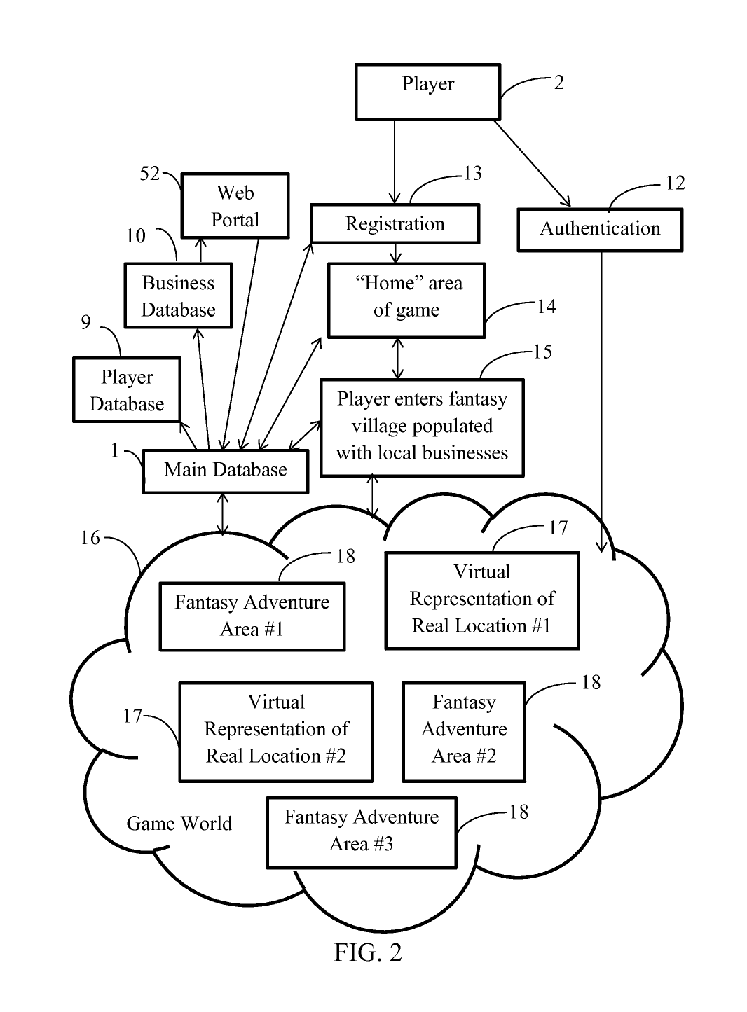

The player's game experience is illustrated in FIG. 2. After downloading the application, the player 2 begins the game on a phone, tablet or computer or other interface 6 device. If the player 2 is not registered, he goes through a registration 13 process and enters information including his postal code, an email address, username and country. If the player 2 is registered, he goes through an authentication 12 process and enters the game at his last position recorded in the main database 11. Represented by an avatar, the newly registered player 2 enters a “Home” area of the game 14 where he will meet one of the game characters that will give him the information to begin the adventure. The player 2, then, enters a fantasy “home village” 15 populated with representations of local businesses that are downloaded from the business database 10 according to their proximity to the player's postal code. The businesses located in this area can change if the player chooses to allow the use of a location service on his interface 6 device. The player's interaction with game characters will send him farther into another region that represents the heart of the game world 16 which is comprised of both fantasy areas 18 and virtual representations of real world geographical regions 17.

The player 2 will always be able to return to the home village and back to his last location at any point in the game to look for coupon opportunities. Within the game world 16, the player 2 will follow the adventure, and pursue various goals that will take him back and forth through fantasy adventure areas 18 and virtual representations of real world locations 17 such as resorts or tourist towns. All of the information regarding the player's progress through the game, including his avatar's last location, is continuously updated through the game server 1 into the main database 11 as long as an internet connection is detected. If there is no internet connection, the information is stored in a file within the game software on the player's device until an internet connection is detected at which time the information is uploaded. The information about the player 2 relative to his interaction with the virtual representations of the subscribing businesses (i.e., coupon accumulation, challenges and quests) is sent to the business database 10 which can be accessed by the business owner 3 through a web portal 52 on the website server 8.

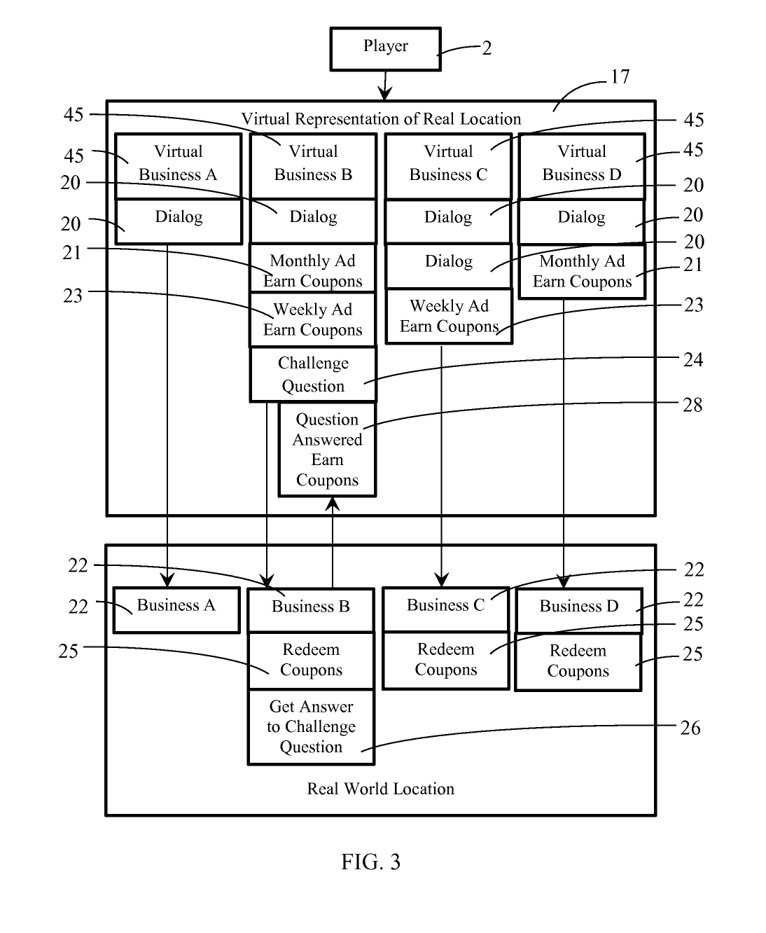

The process of this invention is illustrated in FIG. 3. The player 2 goes to various locations within which are virtual representations of real businesses 45. He interacts with those virtual businesses 45 getting coupon points through dialogs 20, watching monthly ads 21, or weekly ads 23 and getting challenge questions 24. The player 2 earns points and gets information advancing the game play. The player 2 then goes to the real world businesses 22 to redeem coupons 25 and get answers to challenge questions 26. If he gets an answer he needs for a challenge question, the player 2 will then enter the answer in the game to earn more coupon points 28.

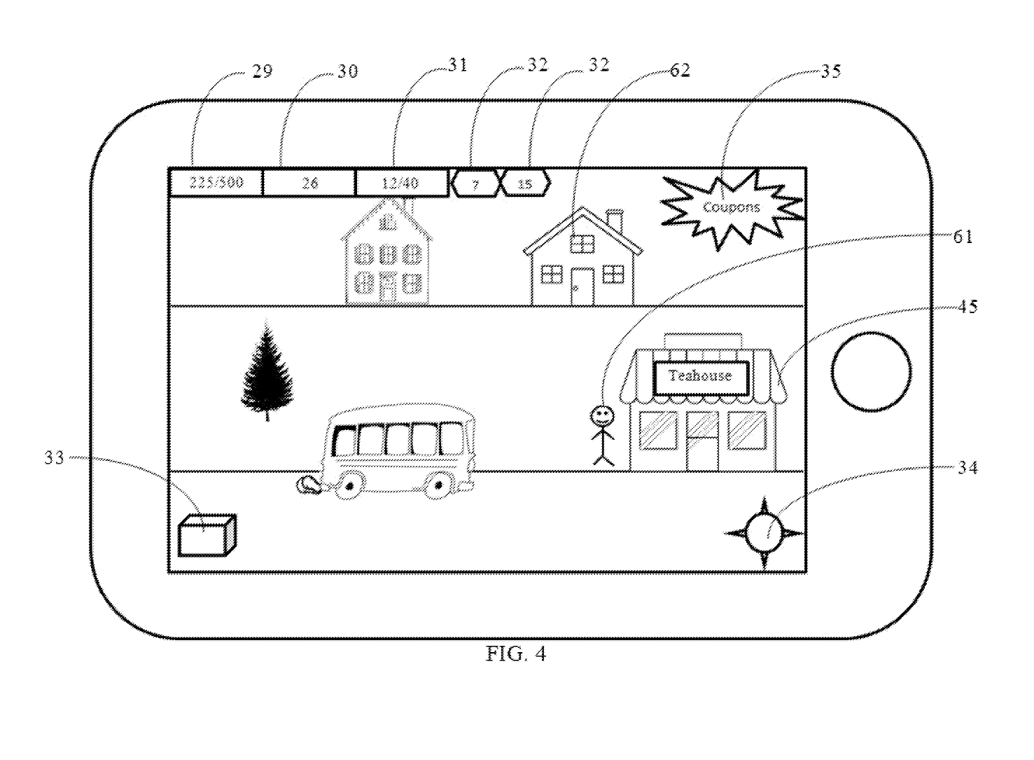

An illustration of a possible view of the main screen of the player 2 on a mobile device is shown in FIG. 4. The view is of a town area. In the upper left corner is the traditional “heads up display” showing the player 2 the following information: a level point display 29 showing how many points the player 2 will need to achieve the next level in the game; a gold coin display 30 showing how many gold coins the player 2 has collected; an energy point display 31 showing how many energy points the player 2 has and the maximum level attainable; and a jewel display 32 showing how many special jewels the player 2 has with which he may buy certain items in the game.

In the lower left corner of FIG. 4, there is an inventory chest icon 33 which, when touched or clicked, opens up an inventory menu screen showing the player 2 types and number of items he has collected.

In the lower right corner of FIG. 4, there is a compass icon 34 which, when touched or clicked, opens up a secondary array of icons which the player 2 may click to change his game settings, enter a social network aspect of the game, and take a screenshot of the game and save to a file.

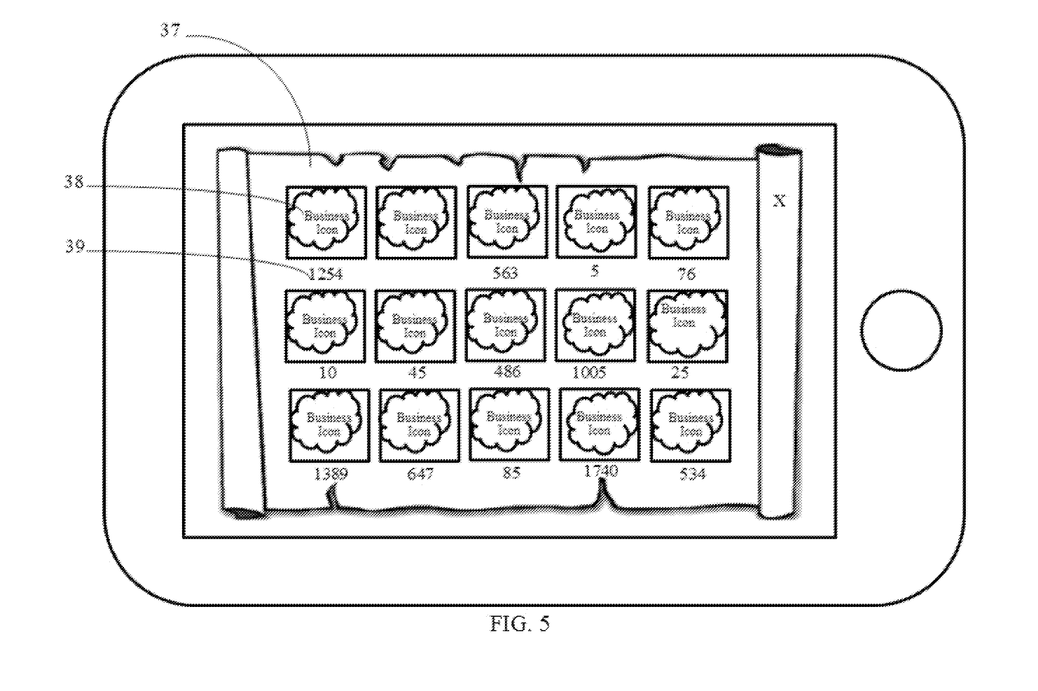

In the upper right corner of FIG. 4, there is a coupon icon 35 which, when touched or clicked, opens up a coupon inventory screen illustrated by FIG. 5.

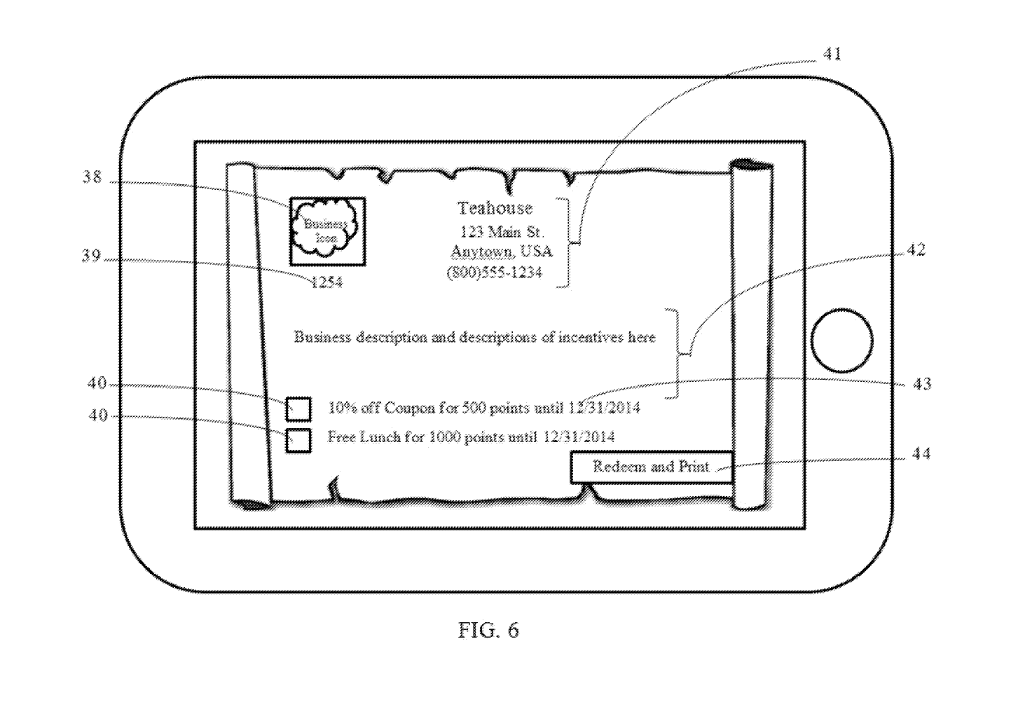

The coupon inventory screen, FIG. 5, opens on a separate background 37 and displays an array of business icons 38. The player 2 can see what coupons are available and the number of coupons 39 he has already collected from each business. Touching or clicking on any business icon 38 opens another screen, illustrated in FIG. 6, showing information for that particular business 22.

FIG. 6 illustrates a possible display of business information. It consists of the name and contact information 41 for, a description 42 of, and the incentives offered 43 by the real world business 22. The player 2 may redeem coupons points at this screen. There are boxes 40 to touch or click next to a listing of incentives 43. The player 2 can touch or click on a “redeem and print” button 44 at the lower right corner. There is a business icon 38 at the upper left corner with the number of coupons 39 underneath showing the player 2 how many he has collected. If the player touches or clicks on this business icon 38, the website of that particular business opens in a new window.

As the player 2 plays through the game, from a town such as that illustrated in FIG. 4, the avatar 61 of the player 2 visits both fantasy business locations 62 and virtual representations of real businesses 45. The player 2 sends the avatar 61 “inside” of a virtual representation of real business 45 by touching or clicking on it.

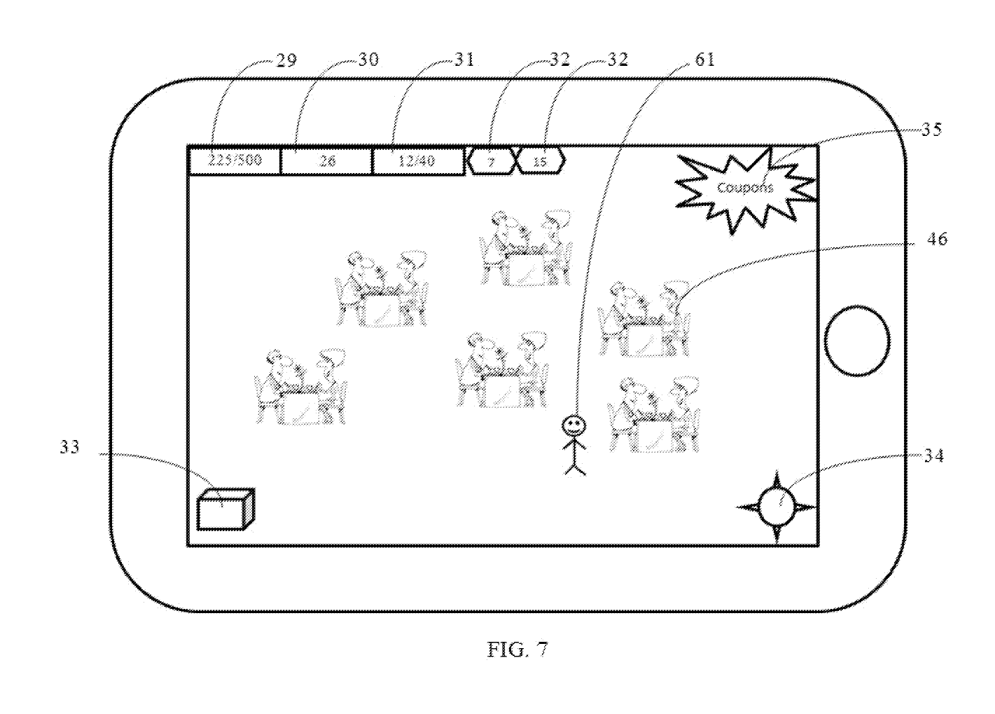

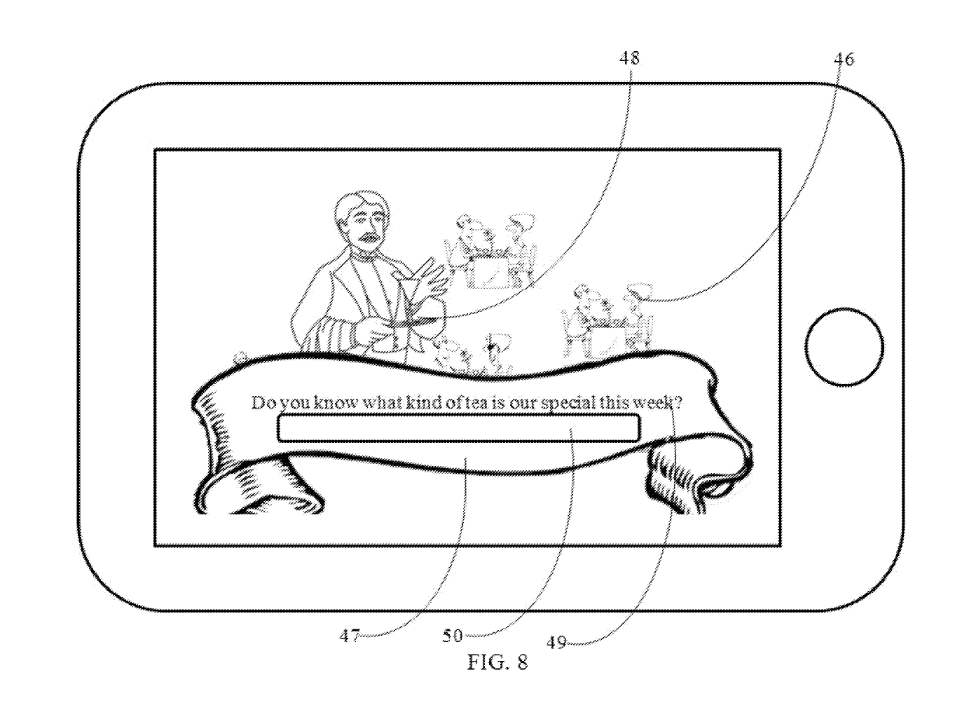

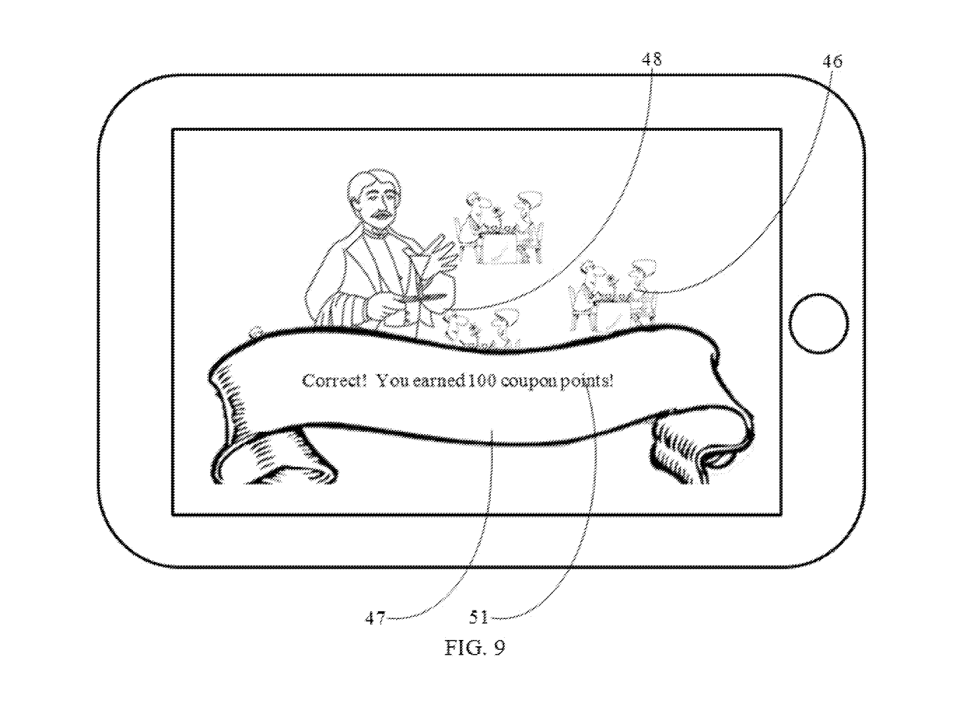

A possible inside of the virtual representation of the inside of a real business is illustrated by FIG. 7. The avatar 61 can “talk” to characters 46 by clicking or touching on them to get additional game information, get information about the business, and view pop up advertisements for coupon points and answer challenges arranged by the business owner 3 for more coupon points. FIG. 8 is an illustration of a challenge screen. A dialog space 47 pops up along with a bust of a character 48 and there is some sort of question 49 posed to the player 2. The player 2 enters the answer in the space provided 50. The player 2 can only answer the question if he has actually visited the real world business location 22. FIG. 9 illustrates when a correct answer entered by the player 2. The statement 51 in the dialog space 47 shows the player 2 that he has answered correctly and indicates how many coupon points he has earned.

This method of advertising is appropriate for many different types of business establishments: commercial, noncommercial, private and public. A business owner 3 purchases a subscription to participate in the game. The monthly subscription fee will be based on the number of characters that will be included at its virtual business location 45, the type of the interaction possible (i.e., informational conversation only, pop up advertising, mini quest or question challenges), and how often the content may change (i.e., unchanging, monthly, weekly, daily). Additionally, a business owner 3 will have the option to have an entire area of devoted to his particular business which would be most appropriate in the case of a resort or theme park where there can be a lot of interactive storylines and adventures all related to a single business. The game developer 4 designs the graphics for each business with input from the business owner 3. The business owner 3 enters and updates his game participation information through a website portal 52 set up for the business.

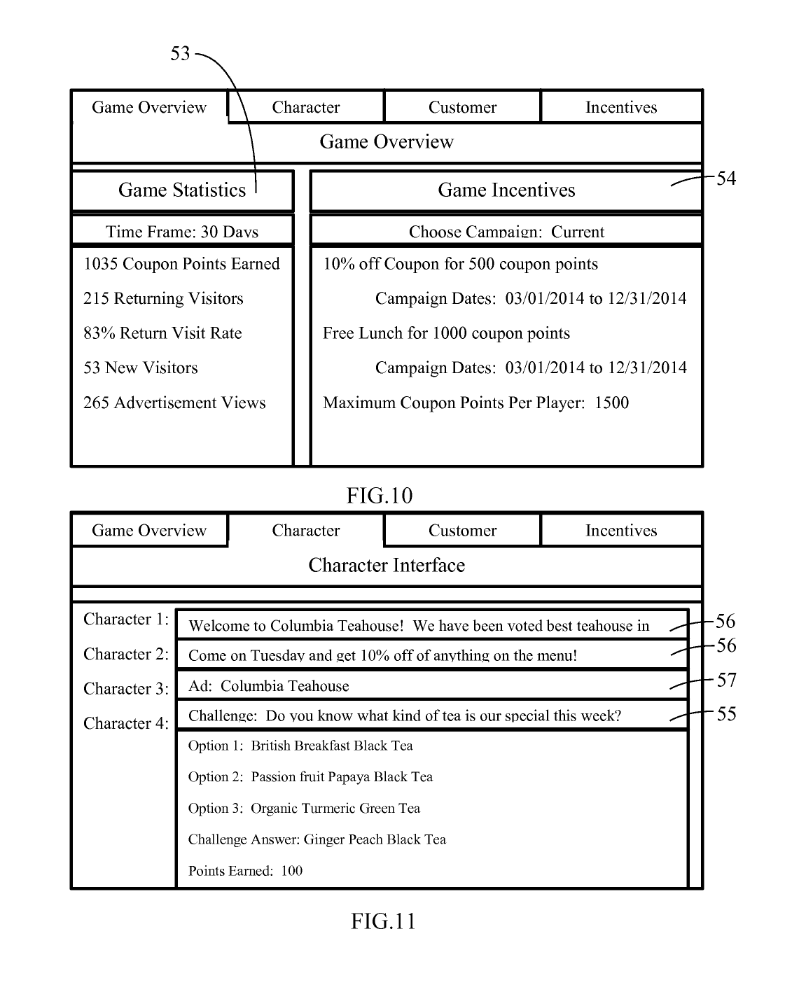

FIG. 10 illustrates a possible Game Overview screen on the website used by a subscribing business owner 3. It lists game statistics 53 which can be viewed for selected time frames as well as incentive campaigns offered 54.

FIG. 11 illustrates a possible Character Interface screen seen by a subscribing business owner 3. It allows the business owner 3 to view and change the type of interaction that the characters 46 located in the virtual representation of the business 45 will have with players 2 visiting that location; for example, the business owner 3 may update the challenge question in an input box 55 weekly to necessitate weekly visits to the actual business location to answer the question correctly. The business owner 3 also updates the dialog of the characters in an input box 56 telling the players about the business 22. The business owner 3 can input advertisements that will pop up that the player must view to earn coupon points 57. The business owner 3 controls all aspects of the character dialog and may choose any combination; thus, he may choose not to have any ads or challenge questions displayed but only dialog or only advertisements, etc.

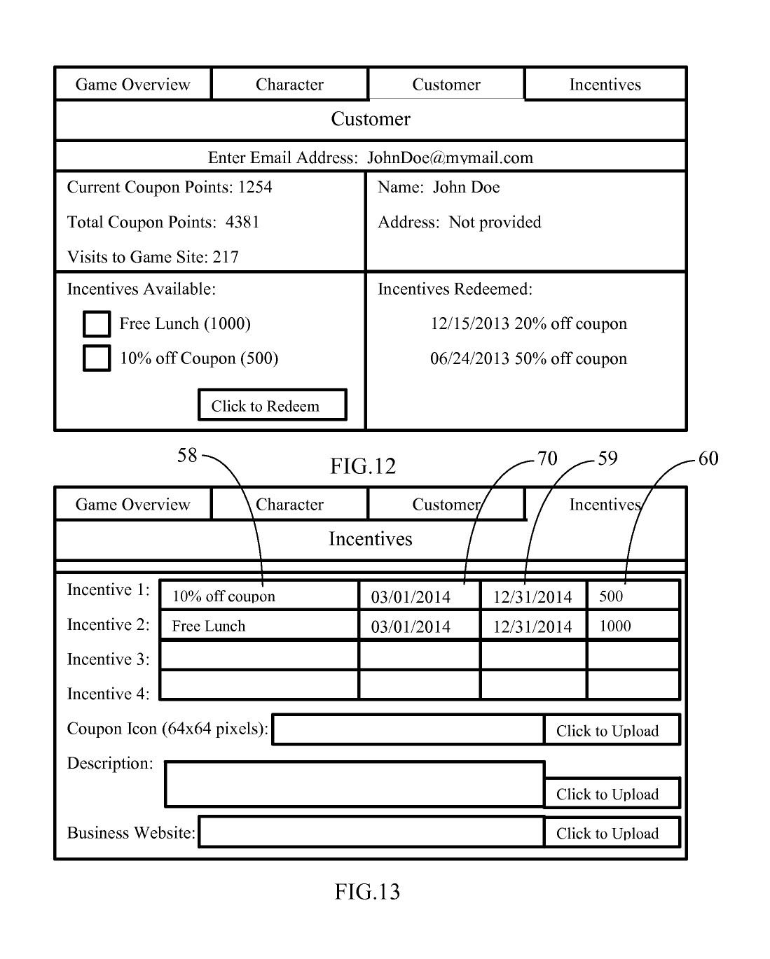

FIG. 12 illustrates a possible Customer screen seen by a subscribing business owner 3. It displays basic information about a player 2 that has accumulated coupon points for that particular business 22. The business owner 3 may also update any in-store redemptions for the coupon points for a player that may not have printed a coupon.

FIG. 13 illustrates a possible Incentives screen seen by a subscribing business owner 3. It allows the business owner 3 to view and change the type of incentives offered by the business 58 and the beginning date 70 and end date 59 of the campaign and the number of coupon points necessary to receive the incentive 60. This screen also allows the business owner 3 to update the coupon icon displayed in the game representing the business 22, a description of the business and/or incentives and the address of the business website.

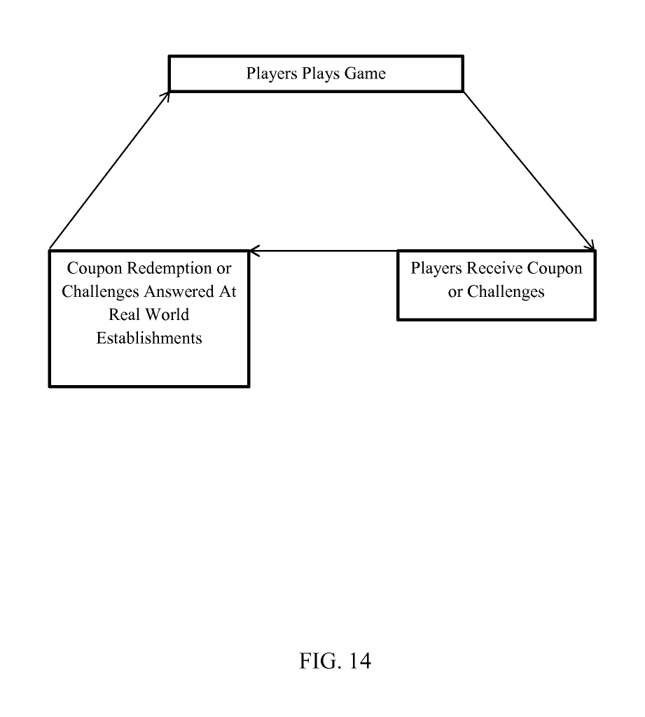

The game creates a cycle, illustrated in FIG. 14, in which the player 2 plays the game, receiving coupons and challenges, which incentivizes him to visit the real business locations where he redeems his coupons and gets answers for the game and then returns to the game continuing with the adventures and continuing the cycle.

According to the above, a unique method of advertising and building relationships with customers and potential customers is provided. The process is incentivized for the player 2 through the use of coupons points and advancement within the game play. It should be understood that the system and method may be implemented in a wide variety of configurations, styles, and media within the boundaries of the invention as described in the claims. This method creates a cycle that can continue indefinitely as long as the player 2 wants to accumulate Coupon Points to redeem at a various business 22 establishments. The player 2 may enter the game for the sole purpose of clicking on advertisements and accumulating points for later redemption. Finally, the player 2 is more likely to frequent real world establishments that are represented virtually in the game as opposed to a competitor due to the incentives he may have available to him through the game. A player 2 that has followed the storylines through a virtual representation of a real world resort will be more likely to choose that resort as his next vacation destination.

### SEQUENCE LISTING

Not applicable.

I claim:

1. A novel method of building awareness of and preference for business establishments through an advertising oriented role playing game on the internet using a player interface connected through a communications network to a game server on which is resident a role-playing game that includes the graphical virtual representations of real world establishments, which the advertisement of and player interaction with both the virtual representations and real world establishments is incentivized with coupon points, prizes, game points, and game advancement, comprising the steps of:
Storing a game medium for use by said game server, said game medium arranged in a structure having a set of graphical displays for fantasy game areas and virtual representations of real world geographical areas containing virtual representations of real world establishments and graphical characters with which the player may interact;
Connecting the player interface to the game server through the communications network;
Presenting to the player virtual representations of a real world establishments with which the player must engage to advance the game play;
Prompting the player to interact with the characters at the virtual representation of the real world establishments, view and listen to advertisements, answer challenge questions and/or complete mini quests;
Providing a database that includes a listing of real world establishments represented in the game for which coupon points and other prizes may be achieved, the number of coupons the player has accumulated, the incentives offered by the establishments, a description of the establishment and its real world location;
Connecting the subscribing business owner interface to the game server through the communications network;
Providing a database that includes the information necessary for the interaction between the said characters and player in the virtual representation of the establishment in the game world including dialog, advertisements, challenge questions and mini-quests; Providing a web portal through which the subscribing business owners may input and update information relevant to their establishments in said database;
Providing rewards useful both within the game and at real world establishments incentivizing the players to continue to play the game, become aware of the establishments, patronize the establishments and build relationships with the establishments.
